(19) United States
(12) Patent Application Publication
(10) Pub. No.: US 2026/0364815 A1
(43) Pub. Date: Nov. 19, 2026

(54) MOBILE ROBOT FOR SERVING AND OPERATING METHOD THEREOF

(71) Applicant: Bear Robotics Korea, Inc., Seoul (KR)

(72) Inventors: Junhee Han, Seoul (KR); Wanhee Lee, Seoul (KR)

(21) Appl. No.: 19/492,497

(22) PCT Filed: Jun. 12, 2023
(86) PCT No.: PCT/KR2023/008037

§ 371 Date: Dec. 11, 2025

(51) Int. Cl. B25J 11/00; B25J 9/00; B25J 9/16

(52) U.S. Cl. CPC B25J 11/008; B25J 9/0009; B25J 9/1638; B25J 9/1651

(57) ABSTRACT

Disclosed are a mobile robot for serving and an operating method thereof. The mobile robot for serving, according to embodiments of the present disclosure, comprises: at least one tray arranged in an accommodation space of a body of the mobile robot and on which an object to be served is placed; a plurality of load cells arranged in the at least one tray; a driving unit arranged at the bottom of the body to move the mobile robot; and a control unit connected to communicate with the plurality of load cells and the driving unit. The control unit may determine, on the basis of sensing values sensed by the plurality of load cells, whether the object being served is placed on the at least one tray, and may change, on the basis of the determination, the moving speed of the mobile robot. Accordingly, when the mobile robot serves, the contents of the object being served can be stably delivered to an ordered customer without overflowing.

### TECHNICAL FIELD

The present disclosure relates to a mobile serving robot and an operating method thereof, and more particularly, to a mobile serving robot and an operating method thereof for stably serving an object ordered by a customer.

### BACKGROUND

Recently, the use of serving robots in stores that provide personal service, such as restaurants, cafes, and bakeries, has increased. Serving robots act as in-store staff, delivering food ordered by customers to tables and collecting empty dishes from tables.

Various researches have been developed to provide more stable and convenient services by using these serving robots.

For example, Korean Patent No. 10-2446843 (hereinafter referred to as “Cited Reference 1”) describes a serving robot having a structure in which a horizontal support of a tray is adjustable in height and can be pulled out.

For example, Korean Patent No. 10-2465049 (hereinafter referred to as “Cited Reference 2”) describes a technology that facilitates serving and clearing food by having a serving robot recognize the height of a table and enable trays to be inserted or removed.

However, Cited References 1 and 2 resolve the inconvenience of customers having to move trays containing food to the table themselves, and do not resolve issues such as objects falling over or broth overflowing while a serving robot moves to serve food containing liquids such as broth.

### DISCLOSURE

### Technical Problem

An object of the present disclosure is to resolve the problems described above and other problems.

An object of some embodiments of the present disclosure is to provide a mobile serving robot and an operation method thereof, which may detect the location of a serving object placed on a tray by itself and perform serving without causing the contents of the serving object to spill or overflow.

An object of some embodiments of the present disclosure is to provide a mobile serving robot and an operation method thereof, which may detect by itself that a serving object is accommodated and tilted to one side and perform serving in consideration of a direction in which the center of gravity is tilted.

An object of some embodiments of the present disclosure is to provide a mobile serving robot and an operation method thereof, which may be implemented to efficiently apply an algorithm according to the purpose of movement of a serving object.

### Technical Solution

To this end, a mobile serving robot according to the present disclosure may detect whether or not the serving object is placed on its own tray.

The mobile serving robot may accurately recognize the location at which the serving object is placed among a plurality of trays of different heights and change the corresponding appropriate movement speed to perform serving more stably.

The mobile serving robot may determine the weight of the serving object and whether the serving object is not placed in the center of the tray but is tilted to one side. When it is determined that the serving object is tilted to one side, serving may be performed in consideration of a direction in which the center of gravity is tilted.

In detail, according to an embodiment of the present disclosure, a mobile serving robot includes at least one tray which is located in an accommodation space of a body of the mobile serving robot and on which a serving object is placed, and a plurality of load cells arranged on the at least one tray, a driving portion located at a lower portion of the body to move the mobile serving robot, and a controller communicatively connected to the plurality of load cells and the driving portion. The controller, based on sensing values detected by the plurality of load cells, may determine whether a serving object is placed on the at least one tray, and control the driving portion to change a movement speed of the mobile serving robot based on the determination.

According to an embodiment, the controller, based on the determination that the serving object has been placed on the at least one tray, may reduce the movement speed of the mobile serving robot below a reference speed, and a degree of reduction in the movement speed may vary depending on a height at which the at least one tray is installed.

According to an embodiment, the at least one tray includes a plurality of trays having different heights from a floor frame of the body, and the plurality of load cells are arranged on left and right sides of each of the plurality of trays. In this case, the controller, based on the sensing values of the plurality of load cells arranged on each of the plurality of trays, may determine a location of a tray on which the serving object is placed, and based on the determined location of the tray, may change a degree of reduction in the movement speed.

According to an embodiment, the controller, based on the sum of the sensing values of first and second load cells arranged on the left and right sides of each of the plurality of trays, may calculate a weight of an object placed on the tray, and based on the calculated weight and the determined location of the tray, may differently set the degree of reduction in the movement speed of the mobile serving robot.

According to an embodiment, the controller may increase the degree of reduction in the movement speed of the mobile serving robot as the location of the tray with the calculated weight determined to exceed a reference value is raised.

According to an embodiment, the controller, based on a difference of the sensing values of first and second load cells arranged on the left and right sides of each of the plurality of trays, may determine whether the serving object placed on the tray is tilted and set a serving path based on the determination.

According to an embodiment, the controller, based on the determination that the serving object placed on the tray is tilted to a left side based on the difference of the sensing values of the first and second load cells, may set a serving path with a left turn priority, and, based on the determination that the serving object placed on the tray is tilted to a right side based on the difference of the sensing values of the first and second load cells, may set a serving path with a right turn priority.

According to an embodiment, the mobile serving robot may further include an inertial measurement unit (IMU) sensor located on the body of the mobile serving robot, wherein the controller, based on detection of a change in sensing values detected by the plurality of load cells being greater than or equal to a reference value while serving in a space on a map at a movement speed changed based on the determination, combines sensing values of the IMU sensor to detect an obstacle and updates the map to display a location corresponding to the detected obstacle.

According to an embodiment, the mobile serving robot may further include an input unit configured to receive a purpose of movement of the serving object, wherein the controller, based on the received purpose of movement and the sensing values detected by the plurality of load cells, determines whether the serving object is placed on the at least one tray.

According to an embodiment, the controller, based on the sensing values detected by the plurality of load cells in response to the purpose of movement for serving being input through the input unit, may determine whether the serving object is placed on the at least one tray, and in response to the purpose of movement for clearing being input through the input unit, may determine that the serving object is not placed on the at least one tray.

An operation method of a mobile serving robot according to an embodiment of the present disclosure may include the following operations. The operation method may include receiving sensing values detected by a plurality of load cells arranged on at least one tray which is located in an accommodation space of a body of the mobile serving robot and on which a serving object is placed, determining whether the serving object is placed on the at least one tray based on the received sensing values, and changing a movement speed of the mobile serving robot based on the determination.

### Advantageous Effects

The effects of a mobile serving robot and an operation method thereof according to the present disclosure are described as follows.

According to the mobile serving robot and the operation method thereof according to some embodiments of the present disclosure, the mobile serving robot may detect the location of the serving object placed on the tray by itself, and may deliver the serving object to the order customer more stably by changing the movement speed or changing the serving path such that the contents of the serving object do not flow or overflow.

According to the mobile serving robot and the operation method thereof according to some embodiments of the present disclosure, even if a serving object is placed and tilted to one side, the mobile serving robot may detect this on its own and change the serving path to turn in a direction in which the center of gravity is tilted, thereby preventing deformation of a state of the serving object in advance.

According to the mobile serving robot and the operation method thereof according to some embodiments of the present disclosure, in the case of food and the like, rapid movement is possible when clearing food by distinguishing between inputs for serving and serving food and determining whether or not to implement an algorithm. Accordingly, efficient management is possible.

### BRIEF DESCRIPTION OF THE DRAWINGS

FIG. 1 is an exemplary diagram of a mobile serving robot according to an embodiment of the present disclosure.

FIG. 2 is an exemplary block diagram illustrating a detailed configuration of a mobile serving robot and a case in which a mobile robot communicates with a server and a customer tablet according to an embodiment of the present disclosure.

FIG. 3 is an exemplary diagram for explaining the stability of each tray during driving for serving according to an embodiment of the present disclosure.

FIG. 4 is a representative flowchart for explaining an operation method of a mobile robot for serving according to an embodiment of the present disclosure.

FIG. 5A, FIG. 5B, and FIG. 5C are exemplary diagrams for explaining a case in which a driving speed is changed differently for each tray on which a serving object is placed according to an embodiment of the present disclosure.

FIGS. 6A, 6B, 7, 8A, and 8B are exemplary diagrams for explaining detecting the tilt of a serving object by using a load cell and changing a serving path based on the same, according to an embodiment of the present disclosure.

FIG. 9 is a flowchart illustrating a method of applying an obstacle detected using a load cell while driving along a serving path to a map according to an embodiment of the present disclosure.

FIG. 10 is another flowchart of a method of determining whether to change a driving speed or a serving path for serving, according to an embodiment of the present disclosure.

### DETAILED DESCRIPTION

Reference will now be made in detail to embodiments of the present disclosure, examples of which are illustrated in the accompanying drawings. Wherever possible, the same reference numbers will be used throughout the drawings to refer to the same or like parts, and redundant description thereof will be omitted. As used herein, the suffixes “module” and “unit” are added or used interchangeably to facilitate preparation of this specification and are not intended to suggest distinct meanings or functions. In describing embodiments disclosed in this specification, relevant well-known technologies may not be described in detail in order not to obscure the subject matter of the embodiments disclosed in this specification. The features of the present disclosure will be more clearly understood from the accompanying drawings and should not be limited by the accompanying drawings, and it is to be appreciated that all changes, equivalents, and substitutes that do not depart from the spirit and technical scope of the present disclosure are encompassed in the present disclosure.

It will be understood that, although the terms first, second, third etc. may be used herein to describe various elements, these elements should not be limited by these terms. These terms are only used to distinguish one element from another element.

It will be understood that when an element is referred to as being “connected to” or “coupled to” another element, it may be directly on, connected or coupled to the other element or intervening elements may be present. In contrast, when an element is referred to as being “directly on,” “directly connected to” or “directly coupled to” another element or layer, there are no intervening elements present.

The terms of a singular form may include plural forms unless otherwise specified.

The terms such as “include” or “comprise” may be construed to denote a certain characteristic, number, step, operation, constituent element, or combination thereof, but may not be construed to exclude the existence of or possibility of addition of one or more other characteristics, numbers, steps, operations, constituent elements, or combinations thereof.

The “mobile serving robot” described in this specification means a machine that autonomously operates in a designated map space and serves or clears food to be served. The mobile serving robot may perform one or more of the following tasks: picking a serving object, delivering the serving object to a destination, or setting the serving object on an order table. The “serving robot” described in the specification is used as the same concept as the mobile serving robot described above.

As an example of a “serving object” described in this specification, food with or without broth is described as an example in consideration of serving and clearing, but is not necessarily limited thereto. For example, the serving object may include, in addition to food, various logistics, goods, plants, animals, and the like.

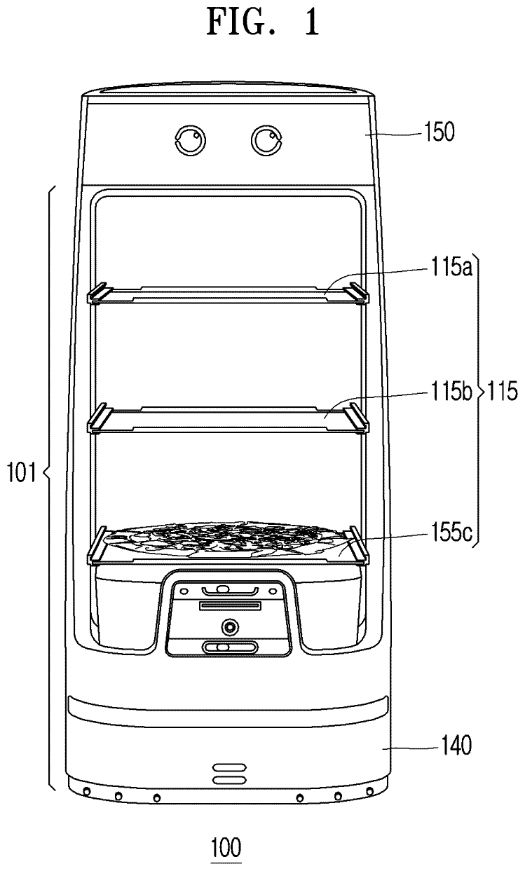

FIG. 1 is an example diagram of a mobile serving robot 100, for example, a serving robot for serving and removing food, according to an embodiment of the present disclosure.

Referring to FIG. 1, the mobile serving robot 100 includes a head portion and a body portion 101. The head portion may include a touchable display 150. The body portion 101 may include an accommodation portion that accommodates a tray 115 on which the serving object is placed, and a driving portion 140 for moving a mobile robot.

Although not shown, the head portion or the body portion 101 may further include one or more camera sensors (e.g., 3D stereo camera or SLAM camera) for determining its own location, a microphone for voice reception, an audio output device (e.g., speaker) for sound output, and one or more obstacle sensors related to driving.

Although not shown, a rechargeable battery and terminal for supplying power to the mobile robot 100 may be provided at a lower portion of the body portion 101, for example, at a rear side of the driving portion 140.

One or more trays 115a, 115b, and 115c are arranged at different heights in the accommodation portion in an upper module of the body portion 101. The driving portion 140 that is mutually detachable and provides a driving function is arranged in a lower module of the body portion 101.

The driving portion 14 may move the mobile robot 100 by having a plurality of driving wheels turn by receiving turning force from a driving motor while the plurality of driving wheels and casters are in uniform contact with the ground.

The tray 115 may include a plurality of trays. The serving object may be placed on each of the trays 115a, 115b, and 115c.

A material for preventing the serving object from falling or slipping may be deposited or a cover or the like may be placed on an upper portion of each of the trays 115a, 115b, and 115c.

Each of the trays 115a, 115b, and 115c may be retracted and withdrawn along guide rails provided on both left and right sides.

Each of the trays 115a, 115b, and 115c may include a plurality of weight sensors, such as load cells, to sense the load of an object placed thereon. In detail, the plurality of load cells may be installed on the left and right bottom surfaces of each of the trays 115a, 115b, and 115c or installed adjacent to each guide rail.

When receiving a sensing value corresponding to a load from a weight sensor, the mobile robot 100 may identify the location of the tray matching each weight sensor. The location of the tray matching the received sensing value means a height at which the corresponding tray is raised based on the floor frame of the driving portion 140 or the bottom of the upper module of the body portion 101.

Each of the trays 115a, 115b, and 115c may be arranged to have different heights. For example, as shown in FIG. 1, a first tray 115a may be positioned at a first height, a second tray 115b may be positioned at a second height lower than the first height, and a third tray 115c may be positioned at a second height lower than the first and second heights.

Vertical intervals of the trays 115a, 115b, and 115c may be the same as shown in FIG. 1, but is not limited thereto. For example, the trays 115a, 115b, and 115c may be arranged to have different vertical intervals to accommodate serving objects of different heights.

The mobile robot 100 may detect that an object is placed on each of the trays 115a, 115b, and 115c and output guidance information (e.g., voice guidance message) to guide the object to the center.

Additional monitoring devices, for example, a camera, may be provided in the body portion 101 to visually check the object placed on the trays 115a, 115b, and 115c.

The mobile robot 100 may perform a driving motion by controlling the driving portion 140 according to a serving/clearing command. For example, when a serving object is placed on one of the trays 115a, 115b, and 115c and a serving/clearing input is received, the mobile robot 100 may start driving along the set serving path.

The mobile robot 100 may determine the location, weight, and tilt of the serving object placed on the trays 115a, 115b, and 115c according to the embodiment of the present disclosure, and may change the movement speed for serving or a serving path in response to the determination.

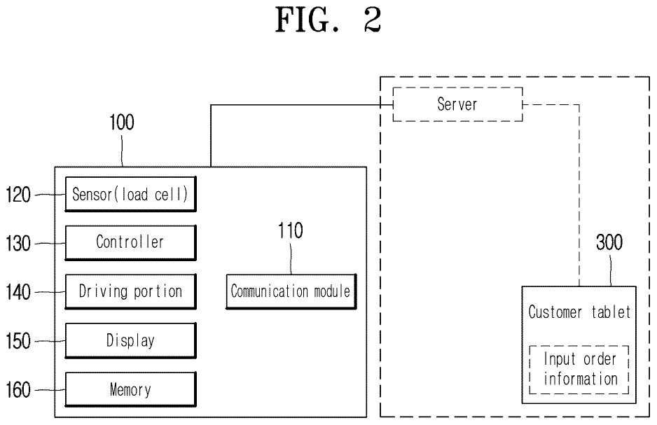

FIG. 2 is an exemplary block diagram illustrating a detailed configuration of a mobile serving robot and a case in which a mobile robot communicates with a server and a customer tablet according to an embodiment of the present disclosure.

Referring to FIG. 2, the mobile serving robot 100 may be connected to a server 200 and communicate with a customer tablet 300 through the server 200.

The mobile robot 100 may include a communication module 110, a sensor 120, a controller 130, the driving portion 140, the display 150, and a memory 160. However, in some embodiments, the mobile robot 100 may include more or fewer components than those described herein.

The server 200 may receive order information input through a customer tablet 300 placed at each table in the store. Here, the customer tablet 300 may be replaced with a kiosk or the like installed at a designated location within the store. The order information input may include a table number of a customer and information about the food ordered (e.g., table number #2 and ordered food: A, B, C, etc.).

The mobile robot 100 may receive the order information input by communicating with the server 200 through the communication module 110.

The communication module 110 may include one or more modules that enable wireless communication between the mobile robot 100 and an external server 200, for example, a control server or an external terminal. The communication module 110 may include one or more modules that connect the mobile robot 100 to one or more networks.

The communication module 110 may communicate with an artificial intelligence server or the like by using wireless Internet communication technologies, for example, wireless LAN (WLAN), wireless-fidelity (Wi-Fi), wireless fidelity (Wi-Fi) direct, digital living network alliance (DLNA), wireless broadband (WiBro), world interoperability for microwave access (WiMAX), high speed downlink packet access (HSDPA), high speed uplink packet access (HSUPA), long term evolution (LTE), and long term evolution-advanced (LTE-A). The communication module 110 may communicate with external terminals or the like by using short-range communication technologies such as Bluetooth™M, radio frequency identification (RFID), infrared data association (IrDA), ultra wideband (UWB), ZigBee, and near field communication (NFC).

Data of one or more order information inputs received from the server 200 may be stored in the memory 160. In this case, data of the order information input may be in the form of data obtained by matching the table number and the ordered food.

In this case, when the ordered food is cooked and placed on the tray of the mobile serving robot 100 and then the table number is input, information about the ordered food matching the table number may be recognized. In this case, information about the recognized ordered food may be compared with information on an object to be careful during serving stored in the memory 160.

As the comparison result, when determining that the recognized information about the ordered food is included in the information on the object to be careful during serving stored in the memory 160, the embodiments according to the present disclosure may be implemented to be performed.

As the comparison result, when determining that the recognized information about the ordered food is not included in the information on the object to be careful during serving stored in the memory 160, the embodiments according to the present disclosure may not be performed or only some operations may be performed.

The sensor 120 is arranged adjacent to the tray and may include a weight sensor, for example, a plurality of load cells, that detects the load of the tray.

In addition to the weight sensor described above, the sensor 120 may include one or more sensors for sensing at least one of information within the mobile robot, information about the surrounding environment surrounding the mobile robot, and user information. For example, the sensor 120 may include at least one of a proximity sensor, an illumination sensor, a touch sensor, an acceleration sensor, a magnetic sensor, a G-sensor, a gyroscope sensor, a motion sensor, an RGB sensor, an infrared (IR) sensor, a finger scan sensor, an ultrasonic sensor, an optical sensor (e.g., a camera, a microphone, or a battery gauge), an environmental sensor (e.g., a barometer, a hygrometer, a thermometer, a radiation detection sensor, a heat detection sensor, or a gas detection sensor), and a chemical sensor (e.g., an electronic nose, a healthcare sensor, or a biometric recognition sensor).

The controller 130 of the mobile robot 100 may receive a sensing value from the sensor 120, for example, a load cell, and determine whether a serving object is placed on a corresponding tray.

The controller 130 may control the driving portion 140 to adjust a movement speed or changing a serving path to drive based on the determination.

The driving portion 140 performs movement and turning of a main body of the mobile robot 100. To this end, the driving portion 140 may include a plurality of driving wheels, a driving motor, and a plurality of casters. Driving of the driving portion 140 may be controlled according to a control command received by the controller 130, and a notification may be provided through an optical output device such as a light emitting diode (LED) before and after driving.

The controller 130 may recognize placement, placement position (e.g., tray number), weight, and tilt of the serving object based on the determination and the sensing value of the load cell 120, and displays visual information related to at least one of these on the display 150.

Map data corresponding to a space in which the mobile robot 100 moves may be stored in the memory 160. The memory 160 may store identification information of the load cell 120 and corresponding tray identification information/location information. In the memory 160, information on a level of reduction in movement speed compared to a reference movement speed based on the determination may be matched and stored for each tray.

The display 150 may be implemented in the form of a touch screen by forming a mutual layer structure with a touch sensor or forming an integral structure. Such a touch screen may function as a user input unit that provides an input interface between the mobile robot 100 and a user, and at the same time provide an output interface.

The controller 130 may include a learning processor (not shown) to perform operations related to an artificial intelligence technology of the mobile robot 100.

The learning processor may train one or more models including an artificial neural network by using training data. The learning processor may be configured to receive, classify, store, and output information to be used for data mining, data analysis, intelligent decision-making, and machine learning algorithms and techniques. The learning processor may be integrated into the mobile robot or may include memory.

The memory 160 may include, for example, at least one type of storage medium of a flash memory type, a hard disk type, a solid state disk type (SSD), a silicon disk drive type (SDD), a multimedia card micro type, a card type memory (e.g., SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, or an optical disk.

In addition to the operations related to the application, the controller 130 typically controls the overall operations of the mobile robot 100. The controller 130 may process signals, data, information, and the like input or output through the components described above, drive an application program stored in the memory 160, or control the driving portion 140 to provide or process appropriate information or functions to the user.

At least some of the above components may operate in cooperation with each other to implement the operation, control, or control method of the mobile serving robot 100 according to various embodiments described below. The operation, control, or control method of the mobile robot 100 may be implemented on the mobile robot by driving at least one application program stored in the memory 160.

The various embodiments described below may be implemented in a recording medium readable by a computer or similar device, for example, using software, hardware, or a combination thereof.

The mobile serving robot 100 according to an embodiment of the present disclosure may determine whether the serving object is placed on at least one tray based on sensing values detected by a plurality of load cells placed on at least one tray on which a serving object is placed. The mobile robot 100 may control the driving portion 140 to change the movement speed of the mobile robot based on the determination.

The controller 130 may control the driving portion 140 to drive the mobile robot 100 at a reduced speed below a reference speed based on a determination that a serving object has been placed on at least one tray.

In this case, a degree of reduction in movement speed may vary depending on a height at which at least one tray is installed.

For example, if a serving object is placed on a first tray 115a located highest from a floor frame, the movement speed may be changed to a first level (e.g., 70%) reduced from the reference value. When a serving object is placed on a second tray 115b located between a third tray 115c located lowest from the floor frame and the first tray 115a, the movement speed may be changed to a second level (e.g., 80%) lower than the first level. In this case, the first level means that the decrease is greater than the second level. When the serving object is placed on the third tray 115c located lowest from the floor frame, the movement speed may be changed to a third level (e.g., 90%) lower than the second level. Here, the third level means that the decrease is less than the first and second levels, and it may be said that a degree of reduction in movement speed is the smallest.

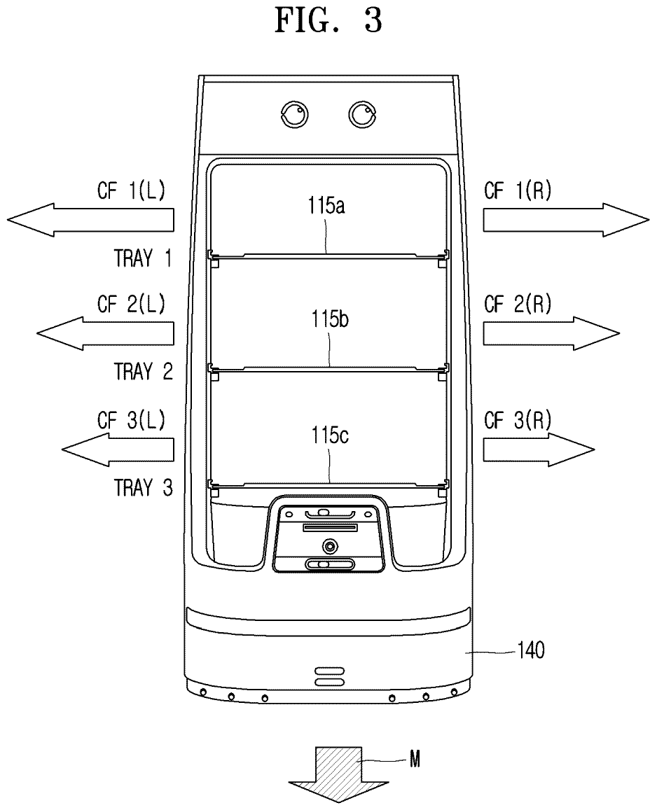

FIG. 3 is an exemplary diagram for explaining the stability of each tray during driving for serving according to an embodiment of the present disclosure.

As shown in the drawing, the plurality of trays 115a, 115b, and 115c arranged at different heights may be placed on the body portion of the mobile robot 100. The mobile robot 100 initiates movement M for serving/clearing food when the serving objects are placed on at least one of the plurality of trays 115a, 115b, and 115c.

During movement M of the mobile robot 100, each of the plurality of trays 115a, 115b, and 115c placed at different heights generate different centrifugal forces.

In detail, the left and right centrifugal force CF1(L) and CF1(R) of the first tray 115a placed at the highest location is the greatest. In addition, the left and right centrifugal force CF2(L) and CF2(R) of the second tray 115b and the left and right centrifugal force CF3(L) and CF3(R) of the third tray 115c are generated in a size corresponding to the height order of each tray.

That is, it may be seen that the higher the tray is placed, the greater the centrifugal force. This means that when a serving object is accommodated on a tray placed at a high position (aside from the ease of placing the serving object for serving/clearing), the stability of movement M is further reduced.

This means that, especially when the serving object placed on the tray contains broth, care needs to be taken to prevent broth from overflowing, and the like during the movement M of the mobile robot 100.

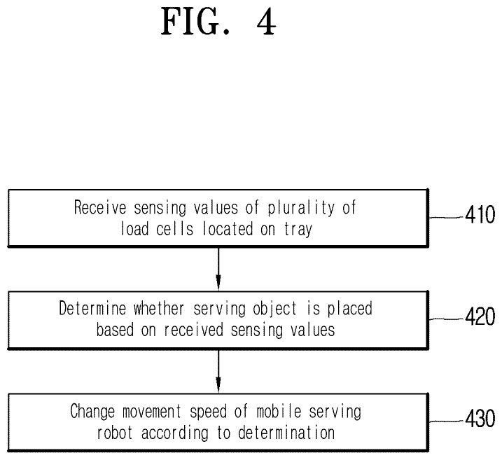

FIG. 4 is a representative flowchart for explaining an operation method of a mobile robot for serving according to an embodiment of the present disclosure. Each process of the operation method illustrated in FIG. 4 is executed by the controller 130 (or controller/processor) of the mobile robot 100 unless otherwise described.

Referring to FIG. 4, the mobile serving robot 100 according to an embodiment of the present disclosure is configured to receive sensing values detected by a plurality of load cells arranged on at least one tray on which a serving object is placed (410).

To this end, at least one tray on which a serving object is placed is accommodated in an accommodation space of the body portion of the mobile robot 100. A load cell for sensing the load is placed on both sides of at least one tray.

The load cell is a transducer for measuring force or load, and when a load is applied, deformation such as compression or extension occurs. This deformation amount of the load cell is detected as an electric signal and transmitted to the controller 130. The controller 130 of the mobile robot 100 may change the detected electric signal into a digital signal and recognize the load of the serving object and can output this as a number as needed.

In the embodiments described herein, it is assumed that a plurality of load cells are respectively arranged on both sides (i.e., left and right) of the tray, but this is not limited thereto. For example, three or more load cells may be placed on a tray to sense load, or this may be implemented using other weight sensors instead of the load cell.

The mobile robot 100 may receive sensing values of load cells for each of multiple trays, and may distinguish and recognize the left and right sensing values of each tray. Accordingly, the mobile robot 100 may recognize the location of the tray matching the received sensing value, more specifically, the location of the load cell placed on the tray.

Continuously, the mobile robot 100 may determine whether the serving object is placed on the tray based on the received sensing values of the plurality of load cells (420). In some embodiments, when a mobile robot 100 includes a plurality of trays and a load cell is arranged on each of the plurality of trays, the mobile robot 100 may determine whether the serving object is placed on each tray.

For example, when a serving object is placed on a tray, load cells placed on both sides of the tray receive a load and thus receive a sensing value corresponding to the deformation amount. On the other hand, if the serving object is not placed on the tray, the deformation amount corresponding to a sensing value of ‘0’ or similar may be received. Accordingly, the controller of the mobile robot 100 may determine whether the serving object has been placed based on the sensing value and recognize the location of the accommodated tray.

In some embodiments, when it is detected that a serving object has been placed, the controller 130 of the mobile robot 100 may generate a serving start signal and perform an operation. For example, if an employee in the store simply places the food ordered by a customer on the tray of the mobile robot 100, the mobile robot 100 may automatically perform an operation of asking whether to start serving.

Then, the mobile robot 100 may adjust the movement speed of the mobile robot based on the determination of whether a serving object is placed on at least one tray (430).

In detail, when it is determined that a serving object is accommodated on at least one tray based on the sensing value of the load cell, the movement speed of the mobile robot may be reduced based on the location of the tray on which the serving object is placed.

In some embodiments, the mobile robot 100 may increase the degree of reduction in movement speed as the location of the tray increases from the floor frame of the mobile robot 100.

For example, it is assumed that the mobile robot 100 includes a plurality of trays installed at different heights, and the serving object may be placed on any of these trays. In this case, the degree of reduction in movement speed may be increased to ensure stability as the serving object is placed on a tray at a higher location.

In some embodiments, the heavier the serving object placed on the tray, the greater the degree of reduction in movement speed. To this end, the weight of an object placed on a tray may be calculated based on the sum of the sensing values of the first and second load cells arranged on the left and right of each of one or more trays of the mobile robot 100.

For example, when a load of 1000 g of food is placed on a tray at the same location and a load of 2000 g of food is placed on a tray, the latter may be adjusted to move at a more reduced speed.

In some embodiments, the mobile robot 100 may set a different degree of reduction in the movement speed of the mobile robot based on a combination of the calculated weight and the location of the tray.

In some embodiments, the degree of reduction in movement speed may be increased based on the specificity of the serving object placed on the tray. Here, the specificity of the serving object may mean, for example, that the serving object contains a broth, or that the serving object has a shape that is prone to tipping over (e.g., a narrow bottle or a bowl with a narrow bottom). The specificity of the serving object may be monitored, for example, through a sensor (e.g., camera sensors, lidar sensors, or distance sensors) that may visually identify the serving objects placed on the tray, or through tagging.

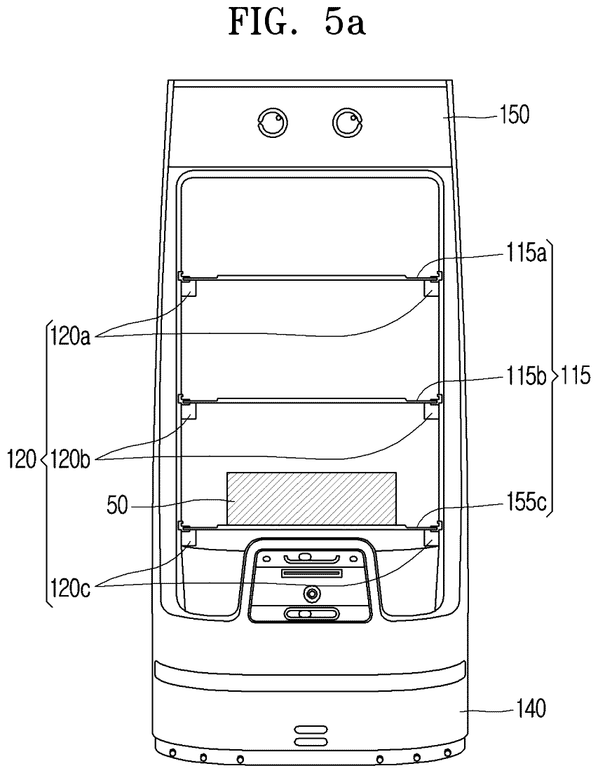

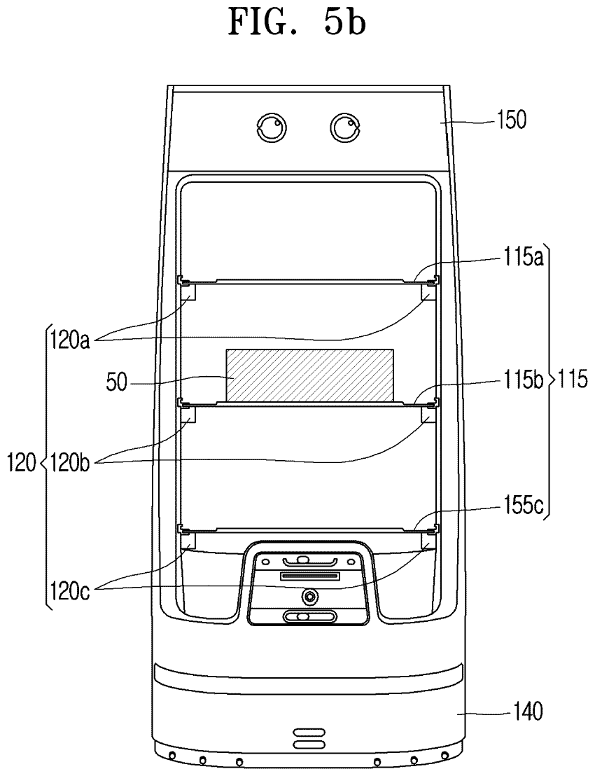

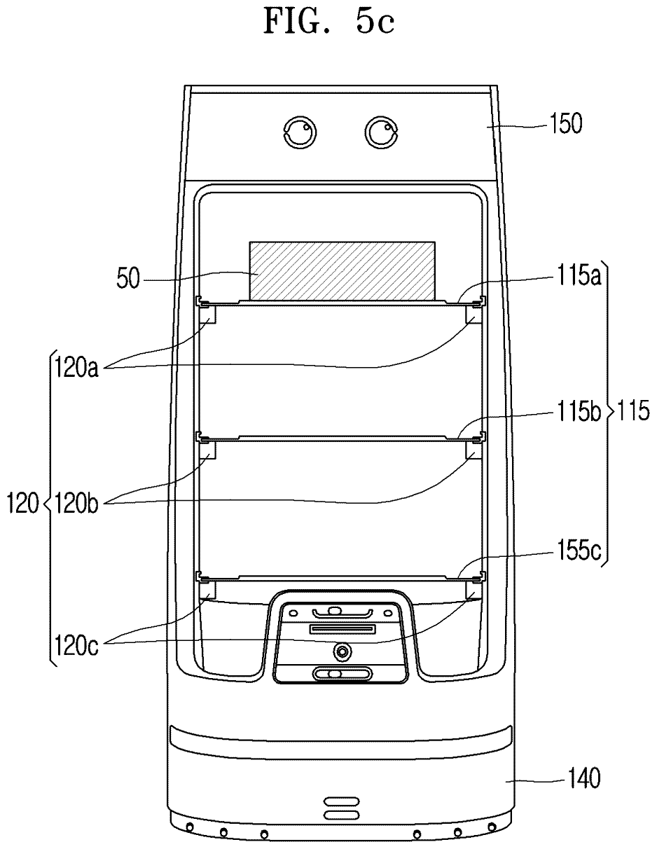

In some embodiments, the mobile robot 100 may change the degree of reduction in the movement speed differently depending on a height at which the tray is installed, based on determination that a serving object has been placed on at least one tray. This will be described in more detail below with reference to FIGS. 5A to 5C.

FIG. 5A, FIG. 5B, and FIG. 5C are exemplary diagrams for explaining a case in which a driving speed is changed differently for each tray on which a serving object is placed according to an embodiment of the present disclosure.

One or more trays are accommodated in an accommodation space of the body portion of the mobile robot 100. Load cells are placed on both sides of each of one or more trays. The controller 130 may monitor the load applied to each tray based on the sensing values of multiple load cells arranged on each of the multiple trays.

As the location of the tray increases from the floor frame of the mobile robot, the center of gravity increases, resulting in lower stability during movement. Accordingly, according to an embodiment of the present disclosure, to ensure stability during movement of the mobile robot and to prevent issues such as broth overflow in advance, different movement speeds are set for each tray.

Referring to FIG. 5a, an accommodation space in which a plurality of trays 115 between the head portion (a portion in which the display 150 is located) of the mobile robot 100 and the driving portion 140 of the body portion are accommodated is provided.

The plurality of trays 115 may include the first tray 115a, the second tray 115b, and the third tray 115c in order from the floor frame of the driving portion 140 upward. The first to third trays 115a, 115b, and 115c illustrated are arranged at equal intervals, but are not limited thereto. For example, intervals of the first to third trays 115a, 115b, and 115c may be configured differently to stably accommodate serving objects of various heights.

A plurality of load cells 120a, 120b, and 120c may be arranged on the left and right bottoms of the first to third trays 115a, 115b, and 115c, respectively.

For example, the load cells 120a, 120b, and 120c may include a first load cell 120a(L) arranged on the left bottom of the first tray 115a with respect to the left, a second load cell 120b(L) arranged on the left bottom of the second tray 115b, and a third load cell 120c(L) arranged on the left bottom of the third tray 115c. In addition, for example, the load cells 120a, 120b, and 120c may include a fourth load cell 120a(R) arranged on the right bottom of the first tray 115a with respect to the right, a fifth load cell 120b(R) arranged on the right bottom of the second tray 115b, and a sixth load cell 120c(R) arranged on the right bottom of the third tray 115c.

In some embodiments, the load cells may include more or fewer than described above. In the former case, an additional load cell may be located at the center bottom of the tray. In the latter case, a single load cell may be positioned centrally on each tray, but in this case, an additional device may be required to calculate the left-right displacement of the serving object, as described below.

Referring to FIGS. 5A to 5C, the degree of reduction in the movement speed of the mobile robot is applied differently depending on the position (i.e., height) of the tray on which the serving object (e.g., food) 50 is placed.

In the example above, when food 50 is placed on the first tray 115a, a load change amount by the first and fourth load cells 120a is detected to determine that the food 50 is placed on the first tray 115a. In this case, serving is performed by reducing the movement speed to about 70% of the reference movement speed.

When the food 50 is placed on the second tray 115b, a load change amount by the second and fifth load cells 120b is detected to determine that the food 50 is placed on the second tray 115b. In this case, serving is performed by reducing the movement speed to about 80% of the reference movement speed.

When the food 50 is placed on the third tray 115c, a load change amount by the third and sixth load cells 120c is detected to determine that the food 50 is placed on the third tray 115c. In this case, serving is performed by reducing the movement speed to about 90% of the reference movement speed.

For example, when the reference movement speed set for the mobile robot 100 is 1 m/s, when the serving object is placed on the first tray 115a, the speed is reduced to 0.7 m/s. When the serving object is placed on the second tray 115b and the third tray 115c, the speed is reduced to 0.8 m/s and 0.9 m/s, respectively, and serving is performed.

The level of reduction in movement speed increases as the height of the tray on which the food 50 is placed increases because the centrifugal force increases and stability decreases as a height increases from the floor frame of the driving portion 140. However, a value of each of the reference movement speed and a level of reduction of the movement speed compared with the reference movement speed may change depending on an environment of a store in which the mobile robot serves, the specifications of the mobile robot, user settings, and the like.

The mobile robot 100 may calculate whether a serving object is placed on a matching tray and the weight of the placed serving object based on the sensing values of the plurality of load cells 120.

In detail, in the above embodiment, the weight of the serving object placed on the tray may be calculated based on the sum of the sensing values of the plurality of load cells arranged on the left and right of each tray. For example, when load change amounts are received from the plurality of load cells 120a arranged on both sides of the first tray 115a and correspond to 450 g and 550 g, respectively, the weight of the serving object placed on the first tray 115a is calculated as (450+550)g=1,000 g. In some embodiments, the calculated weight of the serving object and the identification information (e.g., tray number) of the tray on which the serving object is placed may be displayed through the display 150 of the mobile robot 100.

In some embodiments, the level of reduction in the movement speed may vary differently in consideration of both the calculated load of the serving object and the location (i.e., height) of the placed tray.

In some embodiments, the controller 130 of the mobile robot 100 may adjust a degree of change in the movement speed based on the weight of the serving object.

In detail, when it is determined that the serving object is placed on the second tray 115b and movement speed is reduced to about 80% of the reference speed, the movement speed may be further reduced in proportion to the weight of the serving object. For example, when the weight of the food placed on the second tray 115b is 1000 g, the movement speed may be reduced to 80% of the reference value, and when it exceeds this (e.g., 1500 g), the movement speed may be reduced to (80-constant value) % of the reference value. In this case, the constant value increases in proportion to the weight of the serving object, and may be determined in consideration of a level when the serving object is placed on the first tray (e.g., constant value<=5).

In some embodiments, the controller 130 of the mobile robot 100 may increase a degree of reduction in the movement speed of the mobile robot 100 as the location of the tray in which the weight of the serving object calculated based on the sum of the sensing values of the load cell exceeds the reference value increases.

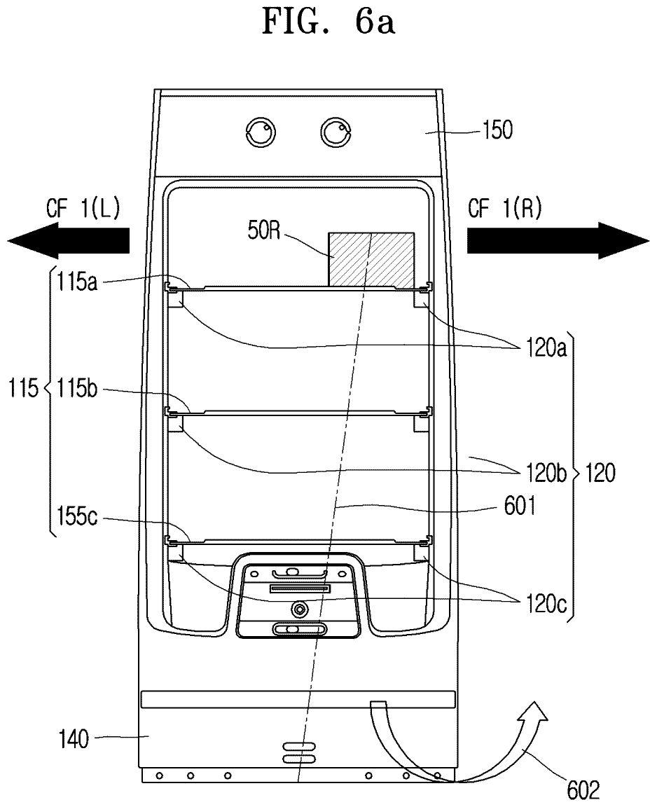

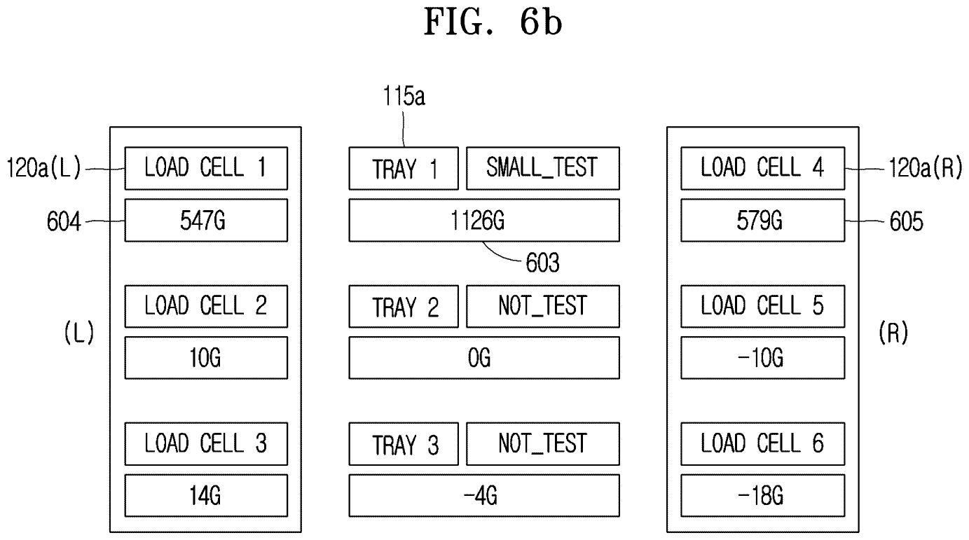

FIGS. 6A, 6B, 7, 8A, and 8B are exemplary diagrams for explaining detecting the tilt of a serving object by using a load cell and changing a serving path based on the same, according to an embodiment of the present disclosure.

The mobile serving robot according to an embodiment of the present disclosure has load cells arranged on both sides of each of a plurality of trays. In this case, the weight applied to the tray on which the serving object is placed among the plurality of trays is determined as the sum of the sensing values of the load cells placed on both sides of the corresponding tray, i.e., the first and second load cells (e.g., the left load cell and the right load cell).

The serving object may be guided to be placed in the center of the tray, but may be placed tilted to either the left or right side of the tray. When serving is performed with the serving object tilted to one side, the center of gravity of the mobile robot 100 is tilted to one side, which may cause deformation of the contents, such as broth overflow, during driving.

Accordingly, in some embodiments of the present disclosure, the controller 130 of the mobile serving robot 100 may determine whether the serving object is tilted to one side based on a difference in each sensing value of a plurality of load cells arranged on both sides of the tray on which the serving object is placed.

The controller 130 may determine the left-right tilting based on a difference in sensing values of the load cells arranged on the left and right of the tray. For example, when the difference between the sensing values of the left and right load cells of the second tray is 100 g, it may be determined that there is left/right tilting.

The controller 130 may compare the size of each sensing value of the plurality of load cells arranged on both sides of the tray on which the serving object is placed to determine a direction in which the serving object is tilted (or the direction in which it is tilted).

In detail, the controller 130 may calculate the tilting direction and tilting degree based on the size of the sensing value of each load cell arranged on the left and right of the tray. For example, when the sensing value of the left load cell of the second tray is 500 g and a difference in the sensing value of the right load cell is 400 g, it may be calculated that there is leftward tilting and a difference of about 100 g occurs.

In this case, the controller 130 may set a different serving path based on the direction in which the serving object is tilted to serve the serving object more stably.

In detail, the controller 130 may determine that the serving object placed on the tray is tilted to the left based on the difference in sensing values of the plurality of load cells arranged on both sides of the tray on which the serving object is placed, and set the serving path with left turn priority.

The controller 130 may determine that the serving object placed on the tray is tilted to the right based on the difference in sensing values of the plurality of load cells arranged on both sides of the tray on which the serving object is placed, and set the serving path with right turn priority.

Accordingly, even if the mobile robot 100 moves while the serving object is placed on the tray with the food tilted to one side, issues such as the food rolling down or the broth overflowing may be prevented in advance.

Referring to FIGS. 6A and 6B, when a serving object, for example, food 50R placed on the first tray 115a of the mobile robot 100 is tilted to the right and placed, the right load cell among the plurality of load cells 120a arranged on both sides of the first tray 115a receives more load. For example, as shown in FIG. 6B, a load 604 corresponding to the sensing value of the left load cell (i.e., the first load cell 120a(L)) of the first tray 115a is ‘547 g’, and a load 605 corresponding to the sensing value of the right load cell (i.e., the fourth load cell 120a(R)) is ‘579 g’. The sum of these loads 604 and 605 is represented as ‘1126 g’, which is a serving object load 603, and a difference therebetween indicates that the serving object is loaded to one side, particularly to the right.

In this case, centrifugal forces CF1(L) and CF1(R) generated in the first tray 115a when the mobile robot 100 moves also differ. That is, the center of gravity is shifted to the right, and thus the right centrifugal force CF1(R) is further increased. Accordingly, the mobile robot 100 sets the serving path to perform a right turn priority 602.

The right turn priority 602 means that when there are a plurality of directions that the mobile robot is capable of selecting to go to a serving table, the mobile robot 100 gives priority to selecting a path for turning to the right. However, when there are no multiple directions to select from and the center of gravity needs to be turned to the right, a vehicle may operate to turn right at a speed slower than a reference turn speed at a turning point.

Although not shown, when a serving object placed on the first tray 115a of the mobile robot 100 is tilted to the left and accommodated, the left load cell among the plurality of load cells 120a placed on both sides of the first tray 115a receives more load.

In this case, centrifugal forces CF1(L) and CF1(R) generated in the first tray 115a when the mobile robot 100 moves also differ. That is, the center of gravity is shifted to the left, and thus the left centrifugal force CF1(L) is further increased. Accordingly, the mobile robot 100 sets the serving path to perform a left turn priority.

The left turn priority path means that when there are a plurality of directions that the mobile robot is capable of selecting to go to a serving table, the mobile robot 100 gives priority to selecting a path for turning to the left. However, when there are no multiple directions to select from and the center of gravity needs to be turned to the left, a vehicle may operate to turn left at a speed slower than a reference turn speed at a turning point.

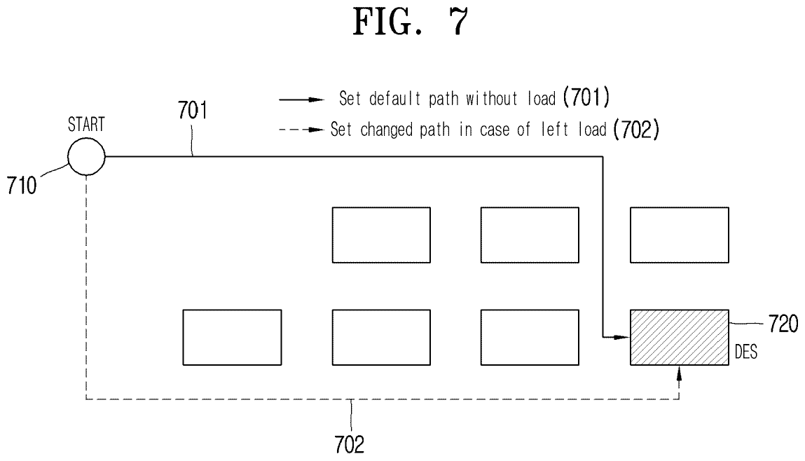

FIG. 7 shows an example of generating a left turn priority path when it is determined that the center of gravity of the mobile robot 100 is tilted to the left. For example, it is assumed that there are multiple paths from a start position 710 to a destination 720, which is the order table. In this case, when there is no load, the shortest path may be set (701) for movement, and when there is a load on the left side, the path may be changed to a left turn priority path (702). The serving path in FIG. 7 is simply illustrated for explanation, but the map of a space served by the actual mobile robot 100 may be more complex than this.

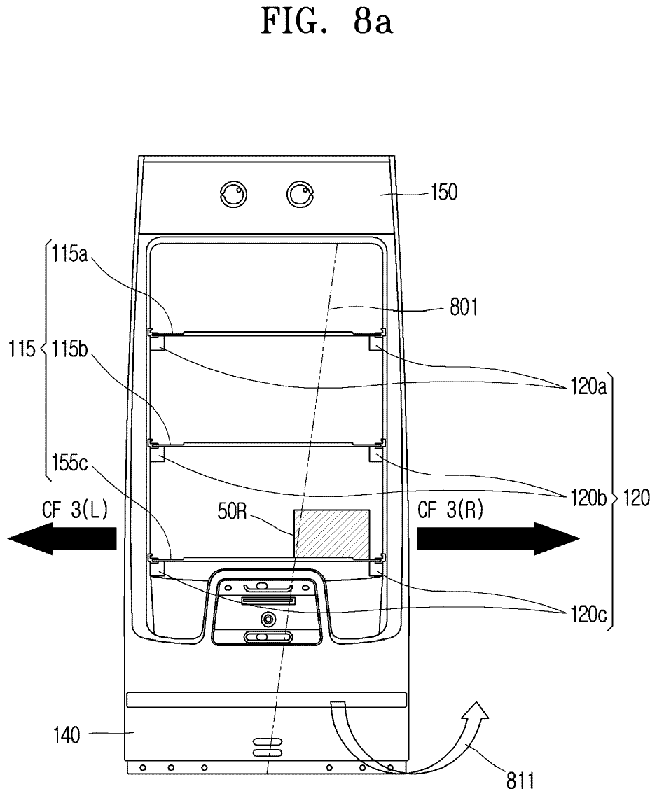

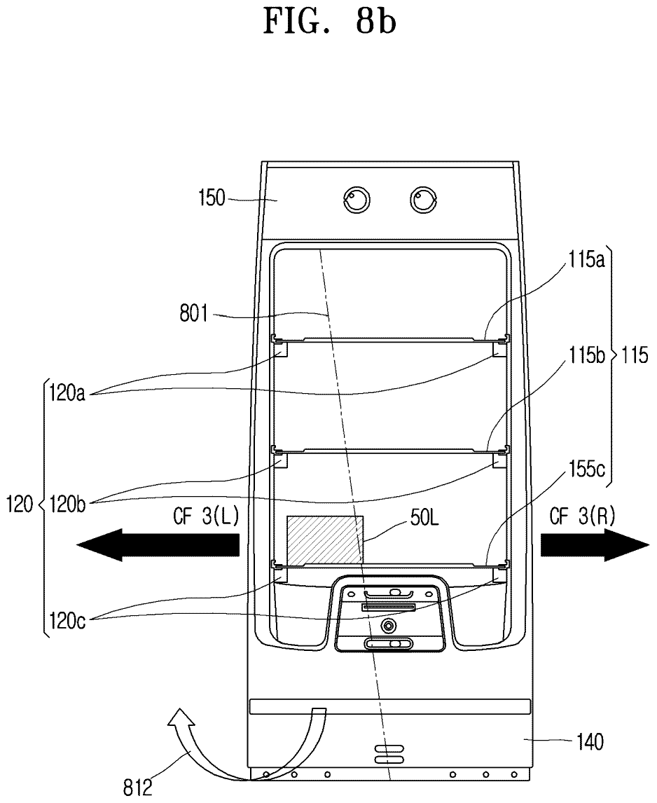

In some embodiments, FIGS. 8A and 8B are to explain controlling both the movement speed and the moving path in consideration of both a location at which the serving object is placed on the tray and the location (i.e., height) of the tray.

First, referring to FIG. 8A, when a serving object 50R is placed with the third tray 115c tilted to the right, the center of gravity is detected to be tilted to the right (801) through s difference in sensing values of the plurality of load cells 120c arranged on both sides of the third tray 115c. Tilting to the right (801) of the center of gravity causes a difference in the left and right centrifugal force CF3(L) and CF3(R). In some examples, visual information may be displayed on the display 150 to indicate the tilt of the serving object and to induce re-placement.

In this case, the mobile robot 100 may generate a path with a right priority rotation 811 based on the detected right tilting and control the driving portion 140 to drive along the changed path. In this case, the changed path is driven by reducing the movement speed to a level corresponding to the location of the third tray 115c, for example, to about 90% of the reference movement speed.

Then, referring to FIG. 8B, when a serving object 50R is placed with the third tray 115c tilted to the left, the center of gravity is recognized to be tilted to the left (802) through a difference in sensing values of the plurality of load cells 120c arranged on both sides of the third tray 115c. Tilting to the left (802) of the center of gravity causes a difference in the left and right centrifugal force CF3(L) and CF3(R). In some examples, visual information may be displayed on the display 150 to indicate the tilt of the serving object and to induce re-placement.

In this case, the mobile robot 100 may generate a path with a left priority rotation 812 based on the recognized left tilting and control the driving portion 140 to drive along the changed path. In this case, the changed path is driven by reducing the movement speed to a level corresponding to the location of the third tray 115c, for example, to about 90% of the reference movement speed. Accordingly, both movement speed optimization and serving path optimization may be obtained simultaneously.

Although not shown, depending on a difficulty of the serving path, the serving object may be placed in the center at a serving start stage, but may shift to one side during serving. For example, when the floor is uneven or has many steps, the serving object may move while passing over the floor, causing the serving object to shift to one side during serving.

The mobile robot 100 receives changes in the sensing values of multiple load cells arranged for each tray while driving for serving, and when the amount of change exceeds a reference value and a difference between multiple sensing values occurs and is maintained for a certain period of time, the corresponding center of gravity tilt and tilt direction may be recognized.

In this case, when the center of gravity is tilted during driving, if it is possible to change the path by turning in the direction of the shift, the serving path is changed again to ensure stable serving.

When it is difficult to change the serving path (e.g., within a certain distance from the serving table), the current movement speed may be reduced to a certain level to ensure stable serving. For example, when a serving object is accommodated on the first table and moves at a speed of 70% of the reference movement speed, and a tilt occurs, it may be designed to move at a speed that is reduced even further, for example, 60 % of the reference movement speed.

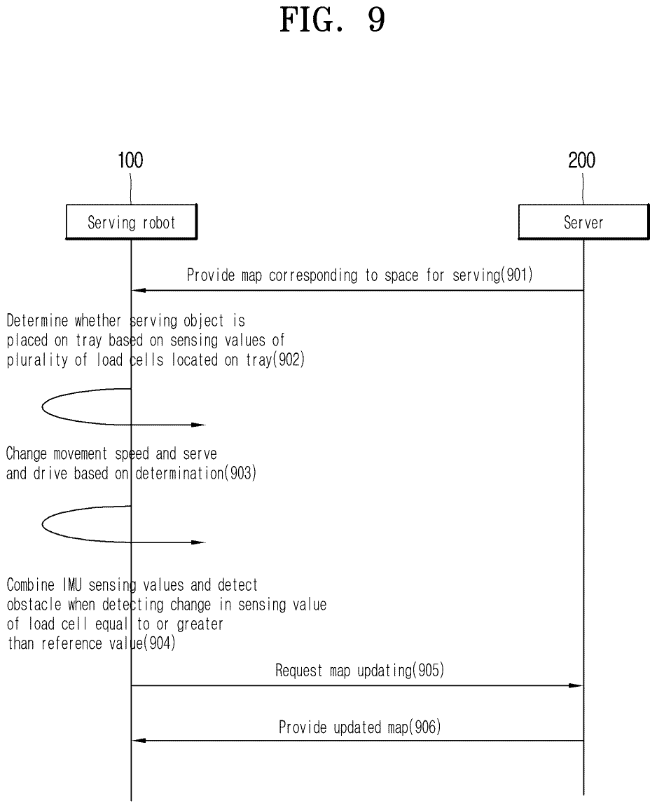

FIG. 9 is a flowchart illustrating a method of applying an obstacle detected using a load cell while driving along a serving path to a map according to an embodiment of the present disclosure.

Each process of an operation flowchart of FIG. 9 may be performed by a controller (or controller/processor) of the mobile serving robot 100 or by the controller/processor of the server 200. Although FIG. 9 illustrates a case in which a map of a space in which the mobile robot 100 moves is provided and updated through the server 200, the present disclosure is not limited thereto. For example, the map may be learned by the controller 130 of the mobile robot 100 and stored in the memory 160.

In an embodiment, the sensor 120 of the mobile robot 100 may include an inertial measurement unit (IMU) sensor placed on one side of the body.

The IMU sensor may be a sensor that accurately measures an angle at which an object is tilted, and may include, for example, a gyroscope, an accelerometer, and/or a geomagnetic sensor. When the sensor includes only a gyroscope, it is called a 6-axis sensor, and when the sensor includes a gyroscope, an acceleration sensor, and a geomagnetic sensor, it is called a 9-axis sensor. The IMU sensor may sense pitch, roll, and yaw rotations around the x-axis, y-axis, and z-axis, respectively. Here, the IMU sensor of the mobile robot 100 may sense changes in the z-axis rotation value that occur when passing over unevenness, steps, and the like on the floor.

While the mobile robot 100 moves, the controller 130 may detect rotational changes in each of the x, y, and z axes through the IMU sensor, thereby recognizing unevenness or steps on the floor.

The controller 130 of the mobile robot 100 may detect a change in the sensing value exceeding a reference value detected by a plurality of load cells while moving at a changed movement speed based on determination that a serving object has been placed on at least one tray. The controller 130 may detect a rotational change greater than or equal to a reference value at least for the z-axis through the sensing value of the IMU sensor.

In this case, the controller 130 may detect a new obstacle on the moving path based on that the sensing values of the plurality of load cells (hereinafter, “first sensing value”) and the sensing values of the IMU sensor (hereinafter, “second sensing value”) have changed by a reference value or more.

Here, detecting an obstacle means detecting the location of the mobile robot 100 when a change greater than or equal to the reference value of the first and second sensing values is detected.

The first and second sensing values refer to a plurality of sensing values collected in real time while the mobile robot 100 moves. Accordingly, the first sensing value may mean a set of first sensing values and may mean a set of second sensing values.

In some embodiments, a new obstacle on the moving path may be detected by additionally combining a set of sensing values of other sensors (e.g., a geomagnetic sensor) among the sensors 120 of the mobile robot 100, for example, third sensing values.

The controller 130 may update the map to display the location of the detected obstacle on the map by additionally combining the first and second sensing values (or the third sensing value). This map update may be performed in real time.

In such a case, the controller 130 may operate to generate a detour route to the corresponding location while driving for serving, or to change an instantaneous movement speed (slow down to the minimum speed) at the corresponding location (or a nearby location).

For example, it is assumed that the controller 130 applies a weight to the direction in which the weight of the tray is weighted and changes the serving path to a turning path with priority in the corresponding direction (i.e., a direction in which the serving object is tilted). In this case, when a new obstacle such as a bump or step is detected while the mobile robot 100 drives along the serving path that has been changed in consideration of the direction in which the serving object is tilted, this may also be changed and applied to the serving path in real time.

According to some embodiments of the present disclosure, the step and requested location may be marked in real time while serving by using the instantaneous change values of a plurality of load cells arranged on a tray and the sensing values of the IMU sensor.

Referring to FIG. 9, the mobile serving robot (hereinafter referred to as “serving robot”) 100 may receive map data for a space for serving within a store from the server 200 (901). Here, the map data may be, for example, map data generated using SLAM, but is not limited thereto.

The serving robot 100 may determine the current location thereof by using the received map data and its own sensors.

The serving robot 100 determines whether a serving object is placed on each of the trays 115a, 115b, and 115c based on the sensing values of the plurality of load cells placed on one or more trays 115a, 115b, and 115c provided on the body (902). In detail, the serving robot 100 may receive sensing values of load cells placed on both sides of each of the trays 115a, 115b, and 115c to determine the location of the tray on which the serving object is placed, the weight of the serving object, and the tilt and tilting direction of the serving object.

The serving robot 100 changes the movement speed when moving for serving based on the determination (903). In this case, the degree of change in movement speed varies depending on the location of the tray on which the serving object is placed.

For example, when a serving object is placed on the first tray located highest from the floor frame of the serving robot 100, the movement speed may be reduced to about 70% of the reference movement speed. On the other hand, when the serving object is placed on the third tray located close to the floor frame of the serving robot 100, the movement speed may be reduced to about 90% of the reference movement speed.

The serving robot 100 may set the serving path as a priority turning path in a direction in which the serving object is tilted in consideration of the direction in which the serving object is tilted. For example, when it is determined that the serving object is tilted to the left based on a difference between the left and right sensing values of the plurality of load cells, the serving path may be changed to a left priority turning path.

The serving robot 100 may simultaneously apply changes in movement speed according to accommodation of the serving object and changes in path according to the tilting of the serving object. For example, when the serving object is placed on the first tray and tilted to the right based on the sensing values of a plurality of load cells, the movement speed may be reduced to about 70% of the reference movement speed and driving may be performed along the right priority turning path.

When driving for serving, the serving robot 100 monitors the sensing value of the sensor 120 in real time. When detecting a change in a load cell sensing value greater than or equal to the reference value, the serving robot 100 additionally combines the sensing values of the IMU sensor to detect a new obstacle (904).

That is, the serving robot 100 may detect a new obstacle that was not previously displayed by combining instantaneous change values of the plurality of load cells and the sensing values of the IMU sensor. The serving robot 100 may mark a location corresponding to the detected obstacle on the map.

The serving robot 100 may then transmit location information corresponding to the detected obstacle to the server 200 through the communication module 110 to update the map (905). For example, the server 200 may update a simultaneous localization and mapping (SLAM) map to display the received location information corresponding to the obstacle.

The server 200 may update the map based on the received location information corresponding to the obstacle and provide the updated map to the serving robot 100, for example, another serving robot (906). Accordingly, the serving robot 100 may then generate a path while avoiding the corresponding location.

In some embodiments, when it is difficult to set a serving path while avoiding a marked location (i.e., when a serving path is set including a marked location), the mobile robot may be controlled to drive at a speed slower than a reference speed when passing the corresponding location. Accordingly, the serving robot 100 may safely pass by without any issues such as broth overflow at least at the marked location.

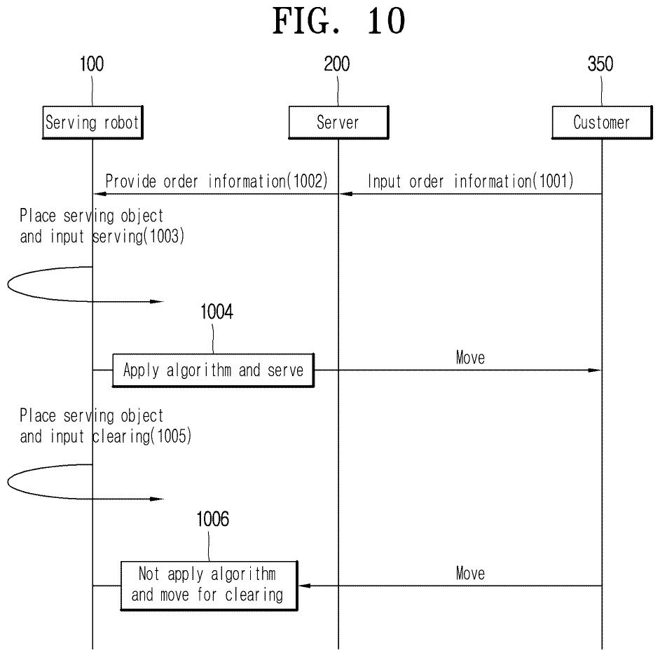

FIG. 10 is another flowchart of a method of determining whether to change a driving speed or a serving path for serving, according to an embodiment of the present disclosure.

Each process of the operation method of FIG. 10 may be performed by the controller (or controller/processor) of the mobile robot unless otherwise described. Some of the processes in FIG. 10 may be optionally performed or omitted.

A mobile serving robot according to an embodiment of the present disclosure may include an input unit configured to receive the purpose of moving a serving object. The input unit is not limited to a specific input device and may be implemented in the form of various input devices such as a voice input device, a touch input device (e.g., a software button), or a push input device (e.g., a hardware button).

For example, if the display 150 of the mobile robot 100 is implemented as a touch screen, the mobile robot 100 may receive the purpose of movement of the serving object through the display 150. Alternatively, for example, the user's voice received through the microphone (not shown) of the mobile robot 100 may be recognized to input the movement purpose of the serving object.

In some embodiments, the controller 130 of the mobile robot 100 may determine whether the serving object is placed on at least one of the trays 115a, 115b, and 115c based on the movement purpose input through the input unit and the sensing values detected by the plurality of load cells 120.

In detail, the controller 130 may determine whether a serving object (e.g., food) is placed on the trays 115a, 115b, and 115c based on sensing values detected by the plurality of load cells 120 in response to the movement purpose input through the input unit being “serving” to the order table.

The controller 130 may determine that a serving object (e.g., food) is not placed on the trays 115a, 115b, and 115c in response to the movement purpose being for “clearing” input through the input unit. That is, the algorithm described above may not be performed regardless of (ignoring) the sensing values detected by the plurality of load cells 120.

In some embodiments, when the controller 130 determines that the serving object (e.g., food) is not placed on the trays 115a, 115b, and 115c, an clearing algorithm for faster clearing may be applied.

Here, the clearing algorithm may include an algorithm/command that increases the movement speed for clearing of the mobile robot 100 to a reference value (i.e., the reference movement speed when the serving object is not placed) or more. Alternatively, the clearing algorithm may include an algorithm/command for changing the movement path for clearing of the mobile robot 100 to the shortest path.

Referring to FIG. 10, a customer 350 in a store may input order information through a tablet on a table (1001). Order information input through the tablet is transmitted to the server 200 (e.g., control server) that manages order information. The order information may include information about the table number in which the customer 350 is located and the ordered food.

The server 200 provides the received order information to the mobile serving robot (hereinafter referred to as “serving robot”) 100 (1002).

Here, providing order information to the serving robot 100 includes the serving robot 100 communicating with the server 200 through the communication module 110 and directly receiving information about the table number and ordered food. In addition, providing order information to the serving robot 100 includes an implementation that recognizes order information matching a table number input by a store employee or the like.

Continuously, the serving robot 100 may detect that the serving object (e.g., food) has been placed on the serving robot 100 and a serving input has been received (1003).

Here, the serving input may be generated by an explicit input as described above (e.g., serving start input/table number input of the customer 350), or the serving input may be generated based on the current location of the serving robot 100 when the serving object is placed. In the latter case, for example, when the serving robot 100 is located in which the serving object is served, accommodation is detected based on the sensing values of a plurality of load cells placed on the tray, and a serving input may be automatically generated after a certain period of time.

In response to receiving a serving input, the serving robot 100 performs an operation according to the algorithm described above (1004).

In detail, the serving robot 100 may determine whether food is placed on at least one tray based on the sensing values of the plurality of load cells 120 and calculate the location and weight of the food. The serving robot 100 may detect whether food is placed on the tray by shifting to the left/right based on the sensing values of the plurality of load cells 120. For example, the serving robot 100 may detect that food is placed on the second tray (i.e., the middle height tray) and recognize that the food is shifted to the left based on a difference in sensing values of a plurality of load cells 120b arranged on the left and right of the second tray. In this case, the serving robot 100 may perform serving by changing (reducing) the movement speed corresponding to the location of the second tray on which the food is placed according to the algorithm. The serving robot 100 may set a left turn priority path with a center of gravity tilted as the serving path according to the algorithm.

The serving robot 100 may detect that a serving object (hereinafter referred to as “leftover food”) (e.g., leftover food) has been placed on the serving robot 100 by the customer 350 or an employee in the store and a leftover food input has been received (1005).

Here, the leftover food input may be generated by an explicit input (e.g., a movement start input for clearing), or the leftover food input may be generated based on the current location of the serving robot 100 when the leftover food is accommodated. In the latter case, for example, when the serving robot 100 moves to a table of the customer 350 while the serving object is not accommodated, and accommodation of the leftover food is detected based on the sensing values of a plurality of load cells placed on the tray at the corresponding location, the leftover food may be automatically generated after a certain period of time.

In response to receiving the leftover food input, the serving robot 100 may determine not to apply the algorithm described above (1006). Accordingly, even if the serving robot 100 detects accommodation of the serving object or detects tilting, the serving robot 100 does not change the movement speed or the driving path.

In some embodiments, the movement for clearing may proceed at a higher movement speed than when the serving object is not placed. In another example, the movement for clearing may be performed along the shortest path than when the serving object is not placed.

As described above, according to the mobile serving robot and the operation method thereof according to an embodiment of the present disclosure, the mobile serving robot may detect the location of the serving object placed on the tray by itself, and may deliver the serving object to the order customer more stably by changing the movement speed or changing the serving path such that the contents of the serving object do not flow or overflow. Even if the serving object is placed and tilted to one side, the mobile serving robot may detect this on its own and change the serving path to turn in a direction in which the center of gravity is tilted, thereby preventing deformation of a condition of the serving object in advance. In the case of food and the like, the algorithm is implemented to enable quick movement when clearing of food by distinguishing between input for serving and input for clearing. Accordingly, efficient management is possible.

The present disclosure described above may be implemented as a computer-readable code (or application or software) on a medium in which a program is recorded. The method of controlling an autonomous vehicle described above may be realized by code stored in memory or the like.

The computer readable recording medium is any data storage device that can store data which can thereafter be read by a computer. Examples of the computer readable recording medium include a hard disk drive (HDD), a solid state drive (SSD), a silicon disk drive (SDD), read-only memory (ROM), random-access memory (RAM), CD-ROM, magnetic tapes, floppy disks, optical data storage devices, carrier waves (e.g., transmission via the Internet), etc. The computer may also include a processor or a controller. Thus, it is intended that the present disclosure cover the modifications and variations of this present disclosure provided they come within the scope of the appended claims and their equivalents.

1. A mobile serving robot comprising:
at least one tray located in an accommodation space of a body of the mobile serving robot, the at least one tray configured to have a serving object placed thereon;
a plurality of load cells arranged on the at least one tray;
a driving portion located at a lower portion of the body configured to move the mobile serving robot; and
a controller communicatively connected to the plurality of load cells and the driving portion, wherein the controller, based on sensing values detected by the plurality of load cells, determines whether the serving object is placed on the at least one tray and controls the driving portion to change a movement speed of the mobile serving robot based on the determination of whether the serving object is placed on the at least one tray.

2. The mobile serving robot of claim 1, wherein the controller, based on the determination that the serving object has been placed on the at least one tray, reduces the movement speed of the mobile serving robot below a reference speed, and
wherein a degree of reduction in the movement speed varies depending on a height at which the at least one tray is installed.

3. The mobile serving robot of claim 2, wherein the at least one tray comprises a plurality of trays having different heights from a floor frame of the body,
wherein the plurality of load cells is arranged on a left side and a right side of each of the plurality of trays, and
wherein the controller, based on the sensing values detected by the plurality of load cells arranged on each of the plurality of trays, determines a location of a tray of the plurality of trays on which the serving object is placed, and
wherein the controller, based on the location of the tray, changes the degree of reduction in the movement speed.

4. The mobile serving robot of claim 3, wherein the controller, based on a sum of the sensing values detected by a first load cell and a second load cell respectively arranged on a left side and a right side of each of the plurality of trays, calculates a weight of an object placed on the tray, and
sets the degree of reduction in the movement speed of the mobile serving robot differently based on the location of the tray and the weight of the object placed on the tray.

5. The mobile serving robot of claim 4, wherein, based on determining that the weight of the object placed on the tray exceeds a reference value, the controller sets a larger degree of reduction in the movement speed of the mobile serving robot for a higher location of the tray.

6. The mobile serving robot of claim 3, wherein the controller, based on a difference between the sensing values of first load cell and the second load cell, determines whether the serving object placed on the tray is tilted and sets a serving path based on the determination of whether the serving object placed on the tray is tilted.

7. The mobile serving robot of claim 6, wherein the controller, based on the determination that the serving object placed on the tray is tilted to a left side, sets the serving path with a left turn priority, and, based on the determination that the serving object placed on the tray is tilted to a right side, sets the serving path with a right turn priority.

8. The mobile serving robot of claim 1, further comprising an inertial measurement unit (IMU) sensor located on the body of the mobile serving robot,
wherein, while the mobile serving robot is moving at the movement speed changed by the controller, the controller, based on detection of a change in the sensing values detected by the plurality of load cells being greater than or equal to a reference value, combines sensing values of the IMU sensor to detect an obstacle and updates the map to display a location corresponding to the obstacle.

9. The mobile serving robot of claim 1, further comprising an input unit configured to receive a purpose of movement of the serving object,
wherein the controller, based on the purpose of movement and the sensing values detected by the plurality of load cells, determines whether the serving object is placed on the at least one tray.

10. The mobile serving robot of claim 9, wherein the controller, in response to the purpose of movement being for serving, determines whether the serving object is placed on the at least one tray based on the sensing values detected by the plurality of load cells, and
wherein the controller, in response to the purpose of movement being for clearing, determines that the serving object is not placed on the at least one tray.

11. An operation method of a mobile serving robot, the operation method comprising:
receiving sensing values detected by a plurality of load cells arranged on at least one tray. the at least one tray located in an accommodation space of a body of the mobile serving robot and configured to have a serving object placed thereon;
determining whether the serving object is placed on the at least one tray based on the sensing values received; and
changing a movement speed of the mobile serving robot based on the determination whether the serving object is placed on the at least one tray.

12. The operation method of claim 11, wherein the changing of the movement speed of the mobile serving robot comprises:
based on determining that the serving object has been placed on the at least one tray, reducing the movement speed of the mobile serving robot below a reference speed; and
varying a degree of reduction in the movement speed depending on a height at which the at least one tray is installed.

13. The operation method of claim 12, wherein the at least one tray comprises a plurality of trays having different heights from a floor frame of the body, and the plurality of load cells are arranged on a left side and a right side of each of the plurality of trays,
wherein determining whether the serving object is placed on the at least one tray includes, based on the sensing values of the plurality of load cells arranged on each of the plurality of trays, determining a location of a tray of the plurality of trays on which the serving object is placed, and
wherein the changing of the movement speed of the mobile serving robot includes, based on the location of the tray, changing the degree of reduction in the movement speed.

14. The operation method of claim 13, wherein determining whether the serving object is placed on the at least one tray further includes, based on a sum of the sensing values of a first load cell and a second load cell respectively arranged on the left side and the right side of each of the plurality of trays, calculating a weight of an object placed on the tray, and
wherein the changing of the movement speed of the mobile serving robot includes;
determining a location of the tray based on the weight of the object; and
setting the degree of reduction in the movement speed of the mobile serving robot differently based on the location of the tray.

15. The operation method of claim 14, wherein the changing of the movement speed of the mobile serving robot further includes, based on determining that the weight of the object exceeds a reference value, setting a larger degree of reduction in the movement speed of the mobile serving robot for a higher location of the tray.
